(19) United States
(12) Patent Application Publication
(10) Pub. No.: US 2026/0048653 A1
(43) Pub. Date: Feb. 19, 2026

(54) MODULAR HOOD PLENUM

(71) Applicant: International Truck Intellectual Property Company, LLC, Lisle, IL (US)

(72) Inventors: Marco Rodolfo Garza Montemayor, San Nicolas de los Garza (MX); Robert Douglas Charles, Saint Charles, IL (US); Rafael Martinez, Jr., Floresville, TX (US); Emily Patricia Kyle, Arlington Heights, IL (US); Yareli Giselle Gurrola Garcia, San Nicolas de los Garza (MX); Khawja Faisal Naveed, Carol Stream, IL (US)

(73) Assignee: International Truck Intellectual Property Company, LLC, Lisle, IL (US)

(21) Appl. No.: 18/804,437

(22) Filed: Aug. 14, 2024

(51) Int. Cl. B60K 13/02; B62D 25/12

(52) U.S. Cl. CPC B60K 13/02; B62D 25/12

(57) ABSTRACT

The present disclosure relates to an embodiment of an improved air intake system of a vehicle incorporating a modular hood plenum configured for receiving various interchangeable components including an engine air pre-cleaner, a cover plate and/or a snow door for mounting separate from the airbox assembly of the vehicle. The modular hood plenum includes a mounting interface that enables mounting of components within the hood rather than the air intake system, allowing easy access for service and/or replacement of components without compromising the air intake system of the vehicle.

### TECHNICAL FIELD

The present disclosure relates generally to an improved hood and the air intake system of a vehicle. Specifically, the present disclosure relates to an air intake system of a vehicle incorporating a modular hood plenum configured for receiving various interchangeable components including an engine air pre-cleaner, a cover plate and/or a snow door for mounting separate from the air cleaner assembly of the vehicle. The modular hood plenum includes a mounting interface that enables mounting of components within the hood of the vehicle rather than in the airbox assembly, allowing easy access for service and/or replacement of components without compromising the air intake system of the vehicle.

### BACKGROUND

Medium and heavy-duty vehicles are often used as snowplows during winter. Due to the direction of air flow around these types of vehicles, vehicle manufacturers often locate the vehicle engine air intake in or near the windshield, which is also known as cowl induction. Medium and heavy-duty vehicles utilize an air inlet location that exhibits consistently high pressure near the cowl but on the side of the hood. This is because airflow with respect to taller medium and heavy-duty vehicles proceeds to a greater extent around the sides of the vehicle, rather than over the top of the vehicle as is the predominant airflow with respect to passenger vehicles and light trucks.

However, there are potential drawbacks to having the vehicle engine air intake located at the base of the vehicle windshield or on the side of the hood near the cowl. When moving air enters a region of turbulent recirculation, or a region of higher pressure and lower relative velocity, it tends to precipitate anything held in suspension. As a result, snow and ice often packs full and plugs the cowl area or hood side engine air intakes, so that airflow entering therein is restricted. The situation of snow and ice entering the vehicle engine air intake is exacerbated by the fact that the opening of the air intake is relatively large, and in some cases, oriented vertically, in order to facilitate ease of routing and maximize airflow. Under certain conditions, sufficient snow and ice may accumulate to completely block the vehicle engine air intake, reducing the amount of airflow available to the vehicle engine and potentially resulting in a no-start condition.

Medium and heavy-duty vehicles used as snowplows are therefore sometimes provided with a feature to provide air to the engine if and when snow plugs the vehicle engine air intake. Specifically, such vehicles are sometimes optionally provided with a snow door integrated with the air cleaner assembly. The snow door is typically a panel in the side of the air cleaner housing that may be opened to allow air from the under hood area into the air cleaner, thereby bypassing the cowl area or hood side engine air intakes. In addition to the snow door being integrated with the air cleaner assembly, the motor used to actuate the snow door is also integrated into the air cleaner assembly. Having the snow door and its motor integrated into the same housing that contains the air cleaner filter element increases the complexity of the air cleaner assembly and poses a high risk to the durability of the air intake system.

Therefore, a need exists for a modular hood plenum configured to receive a variety of optional components relating to the on-engine air cleaner assembly, which can be mounted near, but not within the airbox assembly.

A need also exists for an improved air intake system of a vehicle comprising a modular hood plenum including a mounting interface compatible for receiving various interchangeable components useful in connection with the air intake system of the vehicle. The modular hood plenum is configured for receiving interchangeable components including an engine air pre-cleaner, a cover plate, when no air pre-cleaner is used, and/or a snow door, thereby providing customization of components based on specific vehicle requirements.

A need also exists for a modular hood plenum of a vehicle that provides the option to mount components within the hood of the vehicle, and not within air cleaner assembly, thereby simplifying access for service and replacement of components without compromising the air intake system of the vehicle.

A need also exists for an improved hood for a vehicle having a modular hood plenum configured for mounting various interchangeable components relating to the air intake system of the vehicle. The improve hood is compatible for use across a variety of vehicles including heavy duty and medium duty vehicles, as the modular hood plenum is configured for receiving different air cleaner filters as required by different vehicles.

### SUMMARY

One embodiment of an air intake system of a vehicle comprising a hood, a modular hood plenum disposed within the hood, a hood air intake opening on a side of the hood for receiving air into the modular hood plenum, an on-engine air cleaner assembly connected to the modular hood plenum, wherein the modular hood plenum is configured for receiving interchangeable components mountable within the hood.

One embodiment of an improved hood for a vehicle comprising modular hood plenum disposed within the hood, at least one mounting interface within the modular hood plenum, and, wherein the mounting interface is configured for receiving interchangeable components mountable within the hood.

### BRIEF DESCRIPTION OF THE DRAWINGS

FIG. 1 illustrates a side view of an embodiment of a vehicle incorporating a modular hood plenum of the present disclosure;

FIG. 2 illustrates a top view of a vehicle having a modular hood plenum of the present disclosure;

FIG. 3 illustrates a close-up view of a vehicle having the modular hood plenum of the present disclosure;

FIG. 4 illustrates front top view of a vehicle having the modular hood plenum of the present disclosure;

FIG. 5 illustrates an alternative arrangement of a snow door and a cover plate mounted onto the modular hood plenum of the present disclosure;

FIG. 6 illustrates an alternative arrangement of two pre-cleaner components mounted onto the modular hood plenum of the present disclosure; and,

FIG. 7 illustrates an alternative arrangement of two cover plates mounted onto the modular hood plenum of the present disclosure;

### DETAILED DESCRIPTION

The present disclosure relates generally to the air intake system of a vehicle. Specifically, the present disclosure relates to modular hood plenum, which includes a compatible mounting interface configured for receiving various interchangeable components including an engine air pre-cleaner, a cover plate (when pre-cleaner is not used), and/or a snow door. An advantage of the modular hood plenum is that it offers an option for mounting various components separate from the airbox assembly of the vehicle, thereby improving access for service and replacement without compromising the air intake system of the vehicle.

The present modular hood plenum may be applied to various types of passenger vehicles, recreational vehicles, and commercial vehicles, such as highway or semi-tractors, straight trucks, buses, fire trucks, agricultural vehicles, construction vehicles, snow vehicles, campers, motorhomes, motorcycles, scooters, rail travelling vehicles, and trailers with APUs or refrigeration units. Although the present embodiments relate to diesel engines, the disclosed modular hood plenum may be applied to vehicles having engines configured for variety of fuels. The modular hood plenum of the present disclosure can be incorporated into any vehicle provided with an internal combustion engine having an on-engine air cleaner assembly and may be useful for mounting components to reduce the risk of restricted airflow into the air cleaner primary air inlet.

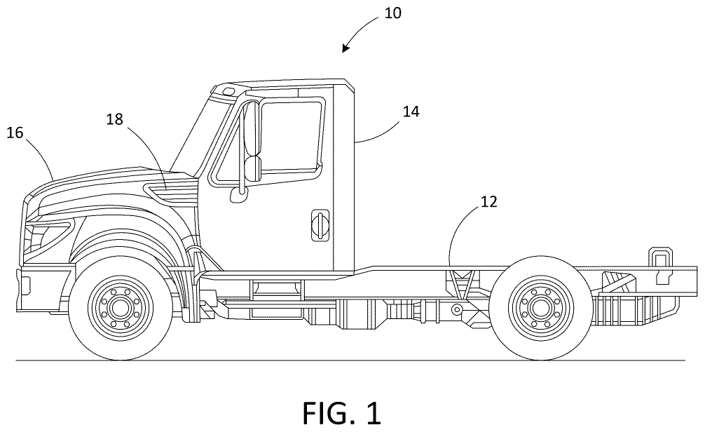

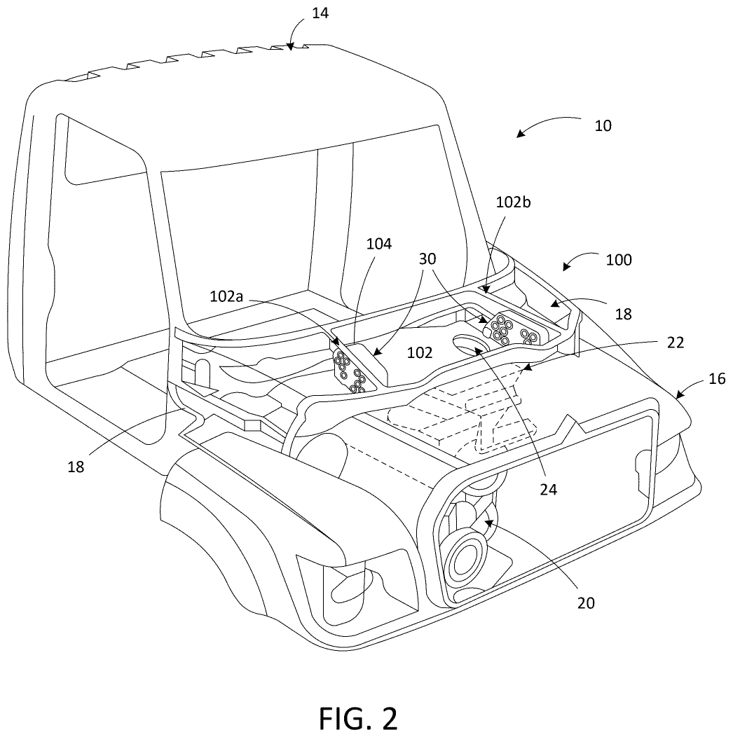

Referring now to FIG. 1, a side view of a vehicle 10 having an embodiment of an air intake system incorporating a modular hood plenum 100 is shown. The vehicle 10 includes a chassis 12, a cab 14, and a hood 16. A hood air intake structure 18 provides an inlet for air to enter the air cleaner system 22 to be used by an engine 20 (FIG. 2).

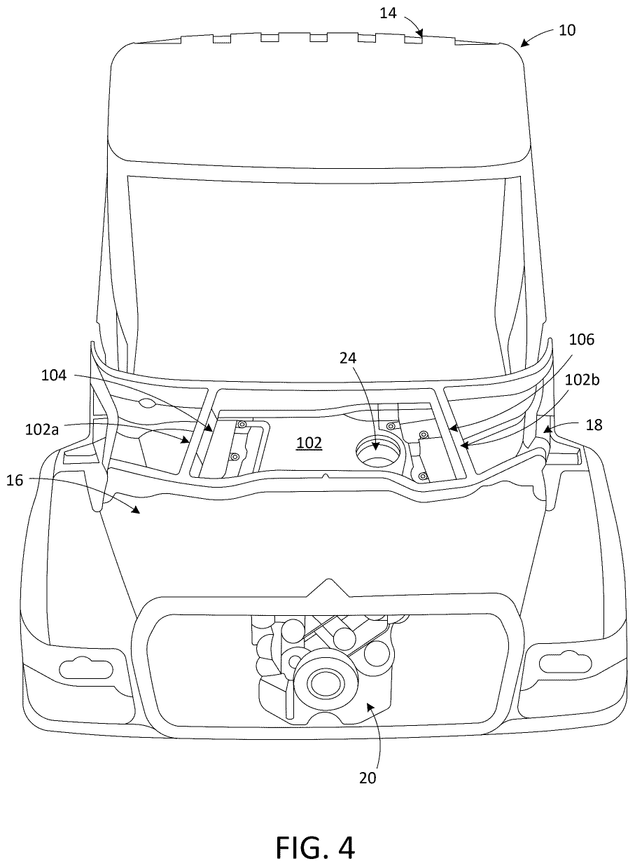

FIG. 2 illustrates a perspective view of a vehicle 10 having a cab 14 and a hood 16, with an engine 20 positioned beneath the hood. An embodiment of the modular hood plenum 100 within the hood 16 according to the present disclosure is also illustrated (FIGS. 2-4). The modular hood plenum 100 extends across a width of the hood 16 and connects to the hood air intake openings 18 positioned on each side of the hood in front of the doors (not shown) on the cab 14. A known airbox or air cleaner assembly 22 includes a primary air inlet 24, which receives air into the air cleaner assembly from the hood air intake opening 18 providing clean, filtered air to the engine 20.

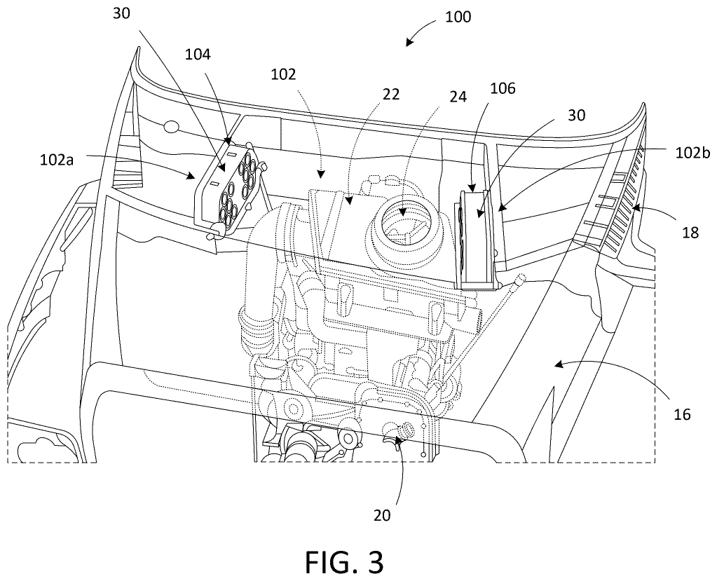

FIG. 3 illustrates a close-up view of the of an embodiment of the modular hood plenum 100. The modular hood plenum 100 includes a channel 102 within the hood 16, extending across the width of the hood 16. The channel 102 provides a pathway for the air travelling from the hood air intake opening 18 to the primary air inlet 24 of the air cleaner assembly 22.

An advantage of the present modular hood plenum 100 is that it permits mounting of interchangeable components associated with the air cleaner assembly within the hood 16, rather than in the air cleaner assembly 22 itself. To accomplish this, the modular hood plenum 100 includes an interface configured for mounting interchangeable components, including an engine pre-cleaner 30, a cover plate 32, when no pre-cleaner is needed, and a snow door 34.

As shown in FIGS. 2-4, there are at least two mounting interfaces, a first mounting interface 104 and a second mounting interface 106, disposed within the interior of the channel 102. Specifically, the first mounting interface 104 and second mounting interface 106 are each positioned along a first rib 102a and a second rib 102b, each rib extending vertically within the channel 102. The orientation of the first rib 102a and the second rib 102b create an enclosure around the primary air inlet 24 to the air cleaner assembly 22.

In an embodiment, the first mounting interface 104 and second mounting interface 106 are configured to receive an engine pre-cleaner 30. FIGS. 2 and 3 illustrate variations of engine pre-cleaners 30 mounted within the respective first mounting interface 104 and second mounting interface 106. The engine pre-cleaner 30 functions to filter the air flowing through channel 102 from the hood air intake opening 18, prior to reaching the primary air inlet 24 of the air cleaner assembly 22. In this manner, the engine pre-cleaner 30 filters incoming of dust and debris, which can impede the operation of the vehicle if the dust and debris reach the air cleaner assembly 22. Location of the engine pre-cleaner filter 30 in the hood 16 provides for easier access and replacement than if the pre-cleaner filter was in the air cleaner assembly.

An advantage of the first mounting interface 104 and second mounting interface 106 is they are configured to receive a variety of interchangeable components, including various types of engine pre-cleaners 30 for filtering the incoming air, and a snow door 34 to prevent snow and ice from entering the air cleaner assembly 22. Typically, these types of components are integrated into the same housing containing the air cleaner assembly 22. However, this arrangement can lead to complexities for replacement and service of various components.

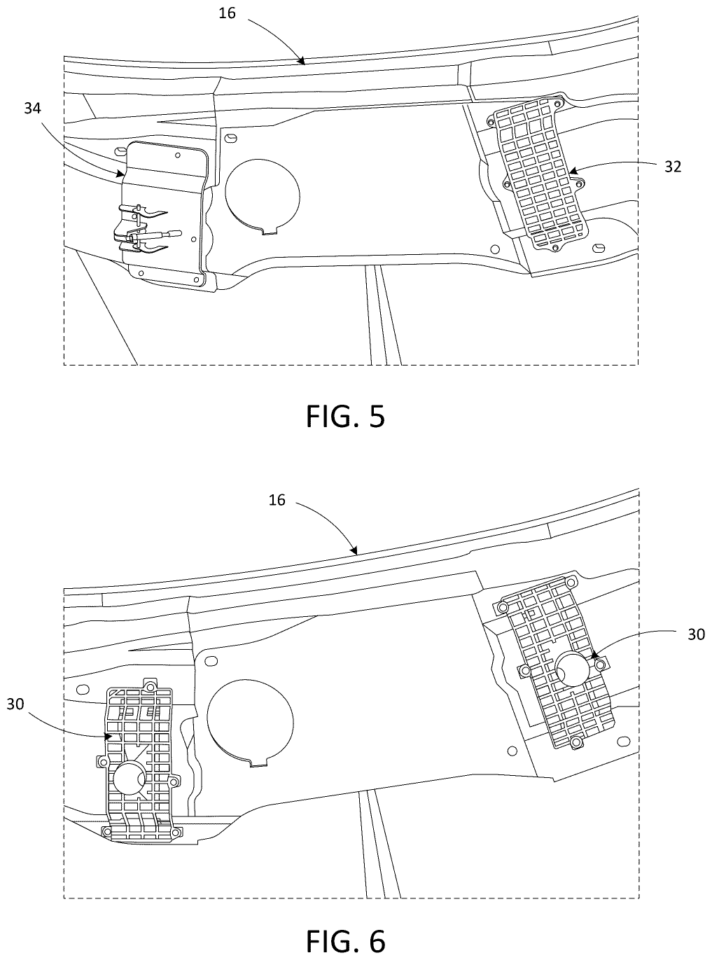

FIGS. 5, 6 and 7 illustrate the advantage of the interchangeability feature of the present disclosure. FIG. 5 illustrates on the underside of the hood 16, an example of an arrangement wherein the first mounting interface 104 and second mounting interface 106 are configured to receive a snow door 34 and a cover plate 32. Snow doors are typically installed within the air cleaner assembly 22, often within the air cleaner housing (not shown). However, failure of the snow door or snow door motor, or any mechanism connecting the two, may require removal and/or replacement of the entire air cleaner assembly 22. At a minimum, repair may involve removal of the air filter element, and/or disconnection of the air cleaner assembly from the air intake system, presenting the possibility of contaminating the intake system and/or damage to the vehicle engine due to ingestion of contaminants. Additionally, failure of the snow door or snow door motor, or any mechanism connecting the two, could result in unobserved damage to the filter, and/or components of the snow door, the snow door motor, or the mechanism connecting the two. The present alternative arrangement of mounting the snow door 34 on the first mounting interface 104 and/or the second mounting interface 106 offers the advantage of easy access to the snow door 34 without having to access the entire air cleaner assembly 22.

FIG. 6 illustrates an example of an arrangement of two engine pre-cleaners 30 on first mounting interface 104 and second mounting interface 106, as shown on the underside of the hood 16.

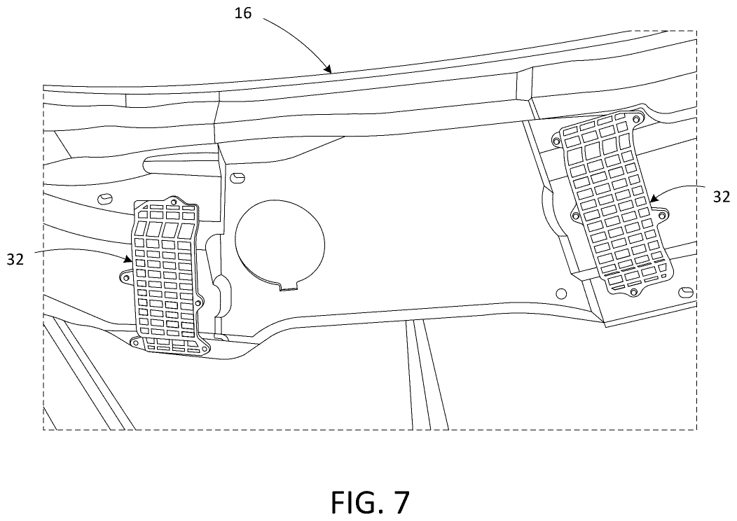

FIG. 7 illustrates yet another example of an arrangement wherein the first mounting interface 104 and second mounting interface 106 are configured to receive a cover plate 32, as shown on the underside of the hood 16. In situations where an engine pre-cleaner 30 is not being used, or is in a different location, a cover plate 32 may optionally be installed in the modular hood plenum 100.

The present modular hood plenum 100 offers numerous advantages including ease of access and replacement of components, as well as a hood configuration offering customization and utility across various vehicle models. Additionally, the present modular plenum 100 also provides compatible mounting options between various interchangeable components, such as a snow door, within the hood rather than in the airbox assembly of a vehicle.

We claim:

1. An air intake system of a vehicle comprising:
a hood;
a modular hood plenum disposed within the hood;
a hood air intake opening for receiving air into the modular hood plenum;
an on-engine air cleaner assembly connected to the modular hood plenum;
wherein the modular hood plenum is configured for receiving interchangeable components mountable within the hood.

2. The modular hood plenum of claim 1, wherein the modular hood plenum comprises at least one mounting interface configured for receiving the interchangeable components.

3. The modular hood plenum of claim 2, wherein the interchangeable components include an engine pre-cleaner, a cover plate and a snow door.

4. The modular hood plenum of claim 1, wherein the modular hood plenum comprises a first mounting interface and an opposing second mounting interface.

5. The modular hood plenum of claim 4, wherein the first mounting interface is configured to receive one of an engine pre-cleaner, a cover plate or a snow door.

6. The modular hood plenum of claim 4, wherein the second mounting interface is configured to receive one of an engine pre-cleaner, a cover plate or a snow door.

7. An improved hood for a vehicle comprising:
a modular hood plenum disposed within the hood;
at least one mounting interface within the modular hood plenum;
wherein the mounting interface is configured for receiving interchangeable components mountable within the hood.

8. The hood of claim 7, wherein the interchangeable components include an engine pre-cleaner, a cover plate and a snow door.

9. The hood of claim 8, wherein the mounting interface is configured to receive one of the engine pre-cleaner, the cover plate or the snow door.

10. The hood of claim 7, wherein the modular hood plenum is adapted for use on a variety of vehicles.
